(19) United States
(12) Patent Application Publication
(10) Pub. No.: US 2026/0057619 A1
(43) Pub. Date: Feb. 26, 2026

(54) AUGMENTED REALITY FOR RENDERING VIRTUAL REPRESENTATIONS OF OBJECTS IN VIDEO CONFERENCING PLATFORMS

(71) Applicant: Zoom Communications, Inc., San Jose, CA (US)

(72) Inventors: Juntao Feng, Hangzhou (CN); Wenchong Lin, Hangzhou (CN); Bo Ling, Saratoga, CA (US); Chong Lv, Hangzhou (CN); Xingguo Zhu, Hangzhou (CN)

(21) Appl. No.: 18/815,175

(22) Filed: Aug. 26, 2024

(51) Int. Cl. G06T 19/00; G06F 3/01; G06T 15/00

(52) U.S. Cl. CPC G06T 19/006; G06F 3/017; G06T 15/00

(57) ABSTRACT

A system for implementing augmented reality in connection with a conferencing platform obtains, via an imaging device, interaction space image information indicative of an interaction space. The system generates, based on the interaction space image information, virtual interaction space information corresponding to a virtual interaction space comprising a virtual three-dimensional (3D) structure representing the interaction space. The system obtains virtual object information for displaying a virtual object within the virtual interaction space. The system provides, for output, rendering information configured to cause a computing device to present, via a display device, the virtual object within the virtual interaction space.

### FIELD

This disclosure generally relates to video conferencing platforms, and, more specifically, to augmented reality for video conferencing platforms.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an electronic computing and communications system.

FIG. 2 is a block diagram of an example internal configuration of a computing device of an electronic computing and communications system.

FIG. 3 is a block diagram of an example of a software platform implemented by an electronic computing and communications system.

FIG. 4 is a block diagram of an example of a conferencing system for delivering conferencing software services in an electronic computing and communications system.

FIG. 5 is a block diagram of an example of an augmented reality (AR) system for incorporating AR in a video conference.

FIG. 6 is a schematic block diagram illustrating an example of an offline preparation process for implementing AR in connection with a conferencing system.

FIG. 7 is a schematic block diagram illustrating an example of an online process for implementing AR in connection with a conferencing system.

FIGS. 8A-8C are diagrams illustrating an example of a virtual representation of a three-dimensional interaction space.

FIG. 9 is a flow diagram showing an example of a technique for implementing AR in connection with a conferencing system.

### DETAILED DESCRIPTION

Conferencing software is frequently used across various industries to support video-enabled conferences between participants in multiple locations. A participant (which may be referred to interchangeably herein as a “user”) refers to a human that is involved in a video conference, whether or not the human is taking any action during the video conference. In some cases, each of the conference participants separately connects to the conferencing software from their own remote locations. In other cases, one or more of the conference participants may be physically located in and connect to the conferencing software from a conference room or similar physical space (e.g., in an office setting) while other conference participants connect to the conferencing software from one or more remote locations. Conferencing software thus enables people to conduct video conferences without requiring them to be physically present with one another. Conferencing software may be available as a standalone software product or it may be integrated within a software platform, such as a unified communications as a service (UCaaS) platform.

Online conferences have become increasingly prevalent in recent years, offering a convenient and efficient way for individuals to collaborate remotely. The current state of video conferencing technology primarily involves two-dimensional (2D) video and audio communication, where participants view each other and interact through flat screens. While advancements have been made in improving video quality, audio clarity, and integrating collaborative tools, these systems often lack the ability to provide a fully immersive experience. Traditional video conferencing systems fail to capture the depth and spatial dynamics of physical interactions, leading to a less engaging and interactive experience. Participants are thus confined to interacting within the limited scope of 2D environments, which can hinder effective communication and collaboration, particularly in scenarios that require a more dynamic and spatially aware interaction.

Implementations of this disclosure address problems such as these by introducing a new approach to online conferencing that leverages augmented reality (AR) technology to create a more engaging and interactive environment for video conferencing. The disclosure focuses on generating a virtual representation of an interaction space. The interaction space is a real-world, physical space such as a conference room, an office, a room in a house, a park bench, a backyard, or any other physical space in which a human may locate themselves during a video conference. The virtual representation of the interaction space may be referred to as a “virtual interaction space”and may include a three-dimensional (3D) structure representing the interaction space.

Some implementations include populating the virtual interaction space with 3D virtual objects that can be manipulated and interacted with by participants of a video conference. In this way, implementations facilitate an AR conference experience that may enhance the conference experience by providing a more immersive and dynamic environment, thereby facilitating a richer and more collaborative experience in which participants can demonstrate ideas, share visual aids, and interact with digital representations in real-time, which may foster clearer communication and a deeper understanding of the presented content. Additionally, the system may support the introduction of 3D virtual participant depictions, enabling participants to express emotions and actions more naturally, thereby creating a more lifelike and engaging presence in the virtual interaction space. The teachings of this disclosure thus significantly improve the immersive experience of video conferencing, making remote communication more effective and interactive.

According to the implementations of this disclosure, an interaction space (e.g., any 3D space within which one or more humans may be located and interact with one or more other humans via a video conferencing platform) may be imaged using 2D and/or 3D imaging techniques and a virtual representation of the interaction space may be generated. The interaction space may include a physical conference room and/or an office, among other non-limiting examples, and may generally refer to an indoor or outdoor space or combination of such spaces. With the captured 3D structure of the interaction space, the virtual representation of the interaction space can be decorated with different 3D virtual objects in realistic geometric positions for entertainment and information transmission. This decoration may be viewed by participants of the video conference at one or more times throughout the video conference. As the virtual objects are projected into the virtual interaction space, an AR conference experience is created. The virtual objects may be controlled, modified, and/or otherwise manipulated by any number of different participants in the video conference. In some implementations, a virtual object may be designed with one or more effects that can be triggered by a participant. For instance, the conferencing platform may employ gesture recognition to facilitate selection of virtual objects, prompting the virtual objects to move, rotate, or to trigger effects such as expanding collapsed information. In some implementations, participants may interact with virtual objects by clicking on the virtual objects.

In some implementations, participants may introduce their 3D virtual participant depictions into the virtual representation of the interaction space. Utilizing pose tracking and face tracking technology, a participant may be able to control the expressions and actions of a 3D virtual participant depiction of the participant as if the participant were physically present in the interaction space. Various 3D effects can be combined into the system for participants to experience, allowing for a wide range of creative implementations. Previously created virtual objects can be downloaded from the internet or captured using a 3D imaging device. In some implementations, the virtual objects may be generated using an artificial intelligence content generation (AICG) system.

Camera calibration may be conducted using intrinsic parameters of the camera that may be provided to the system. Additionally, camera calibration may be performed using computer vision algorithms to obtain intrinsic and extrinsic parameters of the interaction space camera. These parameters facilitate accurate projection of the virtual objects into the virtual interaction space during an online conference as well as realistic interaction with the 3D structure of the virtual interaction space by the virtual objects. An AI-based interaction toolbox may be provided for the participants to interact with virtual objects using hand gestures, allowing control over the virtual objects'positions, poses, and virtual effects.

In some examples of the present disclosure, implementations may include or otherwise use one or more artificial intelligence or machine learning (collectively, AI/ML) systems having one or more models trained for one or more purposes. Use or inclusion of such AI/ML systems, such as for implementation of certain features or functions, may be turned off by default, where a user, an organization, or both must opt-in to utilize the features or functions that include or otherwise use an AI/ML system. User or organizational consent to use the AI/ML systems or features may be provided in one or more ways, for example, as explicit permission granted by a user prior to using an AI/ML feature, as administrative consent configured by administrator settings, or both. Users for whom such consent is obtained can be notified that they will be interacting with one or more AI/ML systems or features, for example, by an electronic message (e.g., delivered via a chat or email service or presented within a client application or webpage) or by an on-screen prompt, which can be applied on a per-interaction basis. Those users can also be provided with an easy way to withdraw their user consent, for example, using a form or like element provided within a client application, webpage, or on-screen prompt to allow individual users to opt-out of use of the AI/ML systems or features.

For example, a software platform, such as a UCaaS platform, may provide artificial intelligence (AI) functionality for use with the software services thereof. Use of the AI functionality may enhance the user experience by automating processes, answering prompted questions with minimal or no disruption to an active communication session, or introducing capabilities previously unavailable to software service users. Such AI functionality may be implemented using one or more machine learning models, which may be trained to process specific types of input and produce specific types of output. For example, machine learning functionality enabled for use during a video conference may be implemented using a large language model (LLM) trained to obtain user requests as natural language prompts and to produce output responsive to the user requests in a same language as that which the prompts are obtained. In one non-limiting example, a video conference participant who joins the video conference after it began may submit a user request to an LLM to ask for a summary of the discussion that occurred during the video conference before the participant joined. The LLM may evaluate a real-time transcription of the video conference (e.g., produced using automated speech recognition or a like tool) to present output concisely summarizing that discussion.

Machine learning models may be implemented for use in a variety of use cases (e.g., language processing, image feature extraction, cyberthreat detection, or recommendation production), using a variety of approaches (e.g., supervised learning, unsupervised learning, or reinforcement learning), and in a variety of structures (e.g., a neural network, decision tree, linear regression, vector machine, Bayesian network, genetic algorithm, or deep learning system).

To enhance privacy and safety, as well as provide other benefits, the AI/ML processing system may be prevented from using a user's or organization's personal information (e.g., audio, video, chat, screen-sharing, attachments, or other communications-like content (such as poll results, whiteboards, or reactions)) to train any AI/ML models and instead only use the personal information for inference operations of the AI/ML processing system. Instead of using the personal information to train AI/ML models, AI/ML models may be trained using one or more commercially licensed data sets that do not contain the personal information of the user or organization.

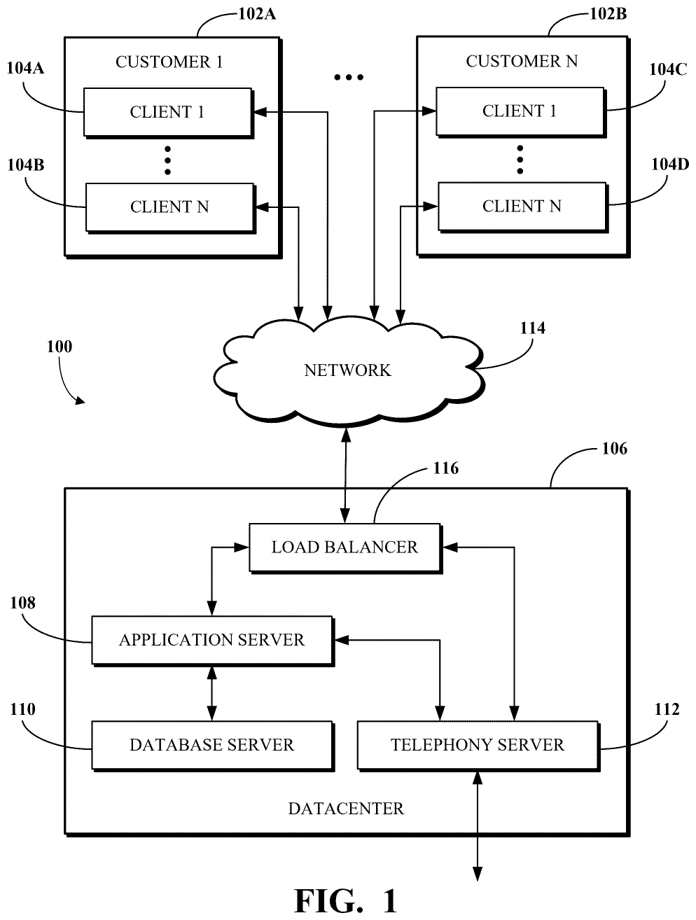

To describe some implementations in greater detail, reference is first made to examples of hardware and software structures used to implement a system for implementing AR in connection with a conferencing platform. FIG. 1 is a block diagram of an example of an electronic computing and communications system 100, which can be or include a distributed computing system (e.g., a client-server computing system), a cloud computing system, a clustered computing system, or the like.

The system 100 includes one or more customers, such as customers 102A through 102B, which may each be a public entity, private entity, or another corporate entity or individual that purchases or otherwise uses software services, such as of a UCaaS platform provider. Each customer can include one or more clients. For example, as shown and without limitation, the customer 102A can include clients 104A through 104B, and the customer 102B can include clients 104C through 104D. A customer can include a customer network or domain. For example, and without limitation, the clients 104A through 104B can be associated or communicate with a customer network or domain for the customer 102A and the clients 104C through 104D can be associated or communicate with a customer network or domain for the customer 102B.

A client, such as one of the clients 104A through 104D, may be or otherwise refer to one or both of a client device or a client application. Where a client is or refers to a client device, the client can comprise a computing system, which can include one or more computing devices, such as a mobile phone, a tablet computer, a laptop computer, a notebook computer, a desktop computer, or another suitable computing device or combination of computing devices. Where a client instead is or refers to a client application, the client can be an instance of software running on a customer device (e.g., a client device or another device). In some implementations, a client can be implemented as a single physical unit or as a combination of physical units. In some implementations, a single physical unit can include multiple clients.

The system 100 can include a number of customers and/or clients or can have a configuration of customers or clients different from that generally illustrated in FIG. 1. For example, and without limitation, the system 100 can include hundreds or thousands of customers, and at least some of the customers can include or be associated with a number of clients.

The system 100 includes a datacenter 106, which may include one or more servers. The datacenter 106 can represent a geographic location, which can include a facility, where the one or more servers are located. The system 100 can include a number of datacenters and servers or can include a configuration of datacenters and servers different from that generally illustrated in FIG. 1. For example, and without limitation, the system 100 can include tens of datacenters, and at least some of the datacenters can include hundreds or another suitable number of servers. In some implementations, the datacenter 106 can be associated or communicate with one or more datacenter networks or domains, which can include domains other than the customer domains for the customers 102A through 102B.

The datacenter 106 includes servers used for implementing software services of a UCaaS platform. The datacenter 106 as generally illustrated includes an application server 108, a database server 110, and a telephony server 112. The servers 108 through 112 can each be a computing system, which can include one or more computing devices, such as a desktop computer, a server computer, or another computer capable of operating as a server, or a combination thereof. A suitable number of each of the servers 108 through 112 can be implemented at the datacenter 106. The UCaaS platform uses a multi-tenant architecture in which installations or instantiations of the servers 108 through 112 is shared amongst the customers 102A through 102B.

In some implementations, one or more of the servers 108 through 112 can be a non-hardware server implemented on a physical device, such as a hardware server. In some implementations, a combination of two or more of the application server 108, the database server 110, and the telephony server 112 can be implemented as a single hardware server or as a single non-hardware server implemented on a single hardware server. In some implementations, the datacenter 106 can include servers other than or in addition to the servers 108 through 112, for example, a media server, a proxy server, or a web server.

The application server 108 runs web-based software services deliverable to a client, such as one of the clients 104A through 104D. As described above, the software services may be of a UCaaS platform. For example, the application server 108 can implement all or a portion of a UCaaS platform, including conferencing software, messaging software, and/or other intra-party or inter-party communications software. The application server 108 may, for example, be or include a unitary Java Virtual Machine (JVM).

In some implementations, the application server 108 can include an application node, which can be a process executed on the application server 108. For example, and without limitation, the application node can be executed in order to deliver software services to a client, such as one of the clients 104A through 104D, as part of a software application. The application node can be implemented using processing threads, virtual machine instantiations, or other computing features of the application server 108. In some such implementations, the application server 108 can include a suitable number of application nodes, depending upon a system load or other characteristics associated with the application server 108. For example, and without limitation, the application server 108 can include two or more nodes forming a node cluster. In some such implementations, the application nodes implemented on a single application server 108 can run on different hardware servers.

The database server 110 stores, manages, or otherwise provides data for delivering software services of the application server 108 to a client, such as one of the clients 104A through 104D. In particular, the database server 110 may implement one or more databases, tables, or other information sources suitable for use with a software application implemented using the application server 108. The database server 110 may include a data storage unit accessible by software executed on the application server 108. A database implemented by the database server 110 may be a relational database management system (RDBMS), an object database, an XML database, a configuration management database (CMDB), a management information base (MIB), one or more flat files, other suitable non-transient storage mechanisms, or a combination thereof. The system 100 can include one or more database servers, in which each database server can include one, two, three, or another suitable number of databases configured as or comprising a suitable database type or combination thereof.

In some implementations, one or more databases, tables, other suitable information sources, or portions or combinations thereof may be stored, managed, or otherwise provided by one or more of the elements of the system 100 other than the database server 110, for example, the client 104A or the application server 108.

The telephony server 112 enables network-based telephony and web communications from and/or to clients of a customer, such as the clients 104A through 104B for the customer 102A or the clients 104C through 104D for the customer 102B. For example, one or more of the clients 104A through 104D may be voice over internet protocol (VOIP)-enabled devices configured to send and receive calls over a network 114. The telephony server 112 includes a session initiation protocol (SIP) zone and a web zone. The SIP zone enables a client of a customer, such as the customer 102A or 102B, to send and receive calls over the network 114 using SIP requests and responses. The web zone integrates telephony data with the application server 108 to enable telephony-based traffic access to software services run by the application server 108. Given the combined functionality of the SIP zone and the web zone, the telephony server 112 may be or include a cloud-based private branch exchange (PBX) system.

The SIP zone receives telephony traffic from a client of a customer and directs same to a destination device. The SIP zone may include one or more call switches for routing the telephony traffic. For example, to route a VOIP call from a first VOIP-enabled client of a customer to a second VOIP-enabled client of the same customer, the telephony server 112 may initiate a SIP transaction between a first client and the second client using a PBX for the customer. However, in another example, to route a VOIP call from a VOIP-enabled client of a customer to a client or non-client device (e.g., a desktop phone which is not configured for VOIP communication) which is not VOIP-enabled, the telephony server 112 may initiate a SIP transaction via a VOIP gateway that transmits the SIP signal to a public switched telephone network (PSTN) system for outbound communication to the non-VOIP-enabled client or non-client phone. Hence, the telephony server 112 may include a PSTN system and may in some cases access an external PSTN system.

The telephony server 112 includes one or more session border controllers (SBCs) for interfacing the SIP zone with one or more aspects external to the telephony server 112. In particular, an SBC can act as an intermediary to transmit and receive SIP requests and responses between clients or non-client devices of a given customer with clients or non-client devices external to that customer. When incoming telephony traffic for delivery to a client of a customer, such as one of the clients 104A through 104D, originating from outside the telephony server 112 is received, an SBC receives the traffic and forwards it to a call switch for routing to the client.

In some implementations, the telephony server 112, via the SIP zone, may enable one or more forms of peering to a carrier or customer premise. For example, Internet peering to a customer premise may be enabled to ease the migration of the customer from a legacy provider to a service provider operating the telephony server 112. In another example, private peering to a customer premise may be enabled to leverage a private connection terminating at one end at the telephony server 112 and at the other end at a computing aspect of the customer environment. In yet another example, carrier peering may be enabled to leverage a connection of a peered carrier to the telephony server 112.

In some such implementations, an SBC or telephony gateway within the customer environment may operate as an intermediary between the SBC of the telephony server 112 and a PSTN for a peered carrier. When an external SBC is first registered with the telephony server 112, a call from a client can be routed through the SBC to a load balancer of the SIP zone, which directs the traffic to a call switch of the telephony server 112. Thereafter, the SBC may be configured to communicate directly with the call switch.

The web zone receives telephony traffic from a client of a customer, via the SIP zone, and directs same to the application server 108 via one or more Domain Name System (DNS) resolutions. For example, a first DNS within the web zone may process a request received via the SIP zone and then deliver the processed request to a web service which connects to a second DNS at or otherwise associated with the application server 108. Once the second DNS resolves the request, it is delivered to the destination service at the application server 108. The web zone may also include a database for authenticating access to a software application for telephony traffic processed within the SIP zone, for example, a softphone.

The clients 104A through 104D communicate with the servers 108 through 112 of the datacenter 106 via the network 114. The network 114 can be or include, for example, the Internet, a local area network (LAN), a wide area network (WAN), a virtual private network (VPN), or another public or private means of electronic computer communication capable of transferring data between a client and one or more servers. In some implementations, a client can connect to the network 114 via a communal connection point, link, or path, or using a distinct connection point, link, or path. For example, a connection point, link, or path can be wired, wireless, use other communications technologies, or a combination thereof.

The network 114, the datacenter 106, or another element, or combination of elements, of the system 100 can include network hardware such as routers, switches, other network devices, or combinations thereof. For example, the datacenter 106 can include a load balancer 116 for routing traffic from the network 114 to various servers associated with the datacenter 106. The load balancer 116 can route, or direct, computing communications traffic, such as signals or messages, to respective elements of the datacenter 106.

For example, the load balancer 116 can operate as a proxy, or reverse proxy, for a service, such as a service provided to one or more remote clients, such as one or more of the clients 104A through 104D, by the application server 108, the telephony server 112, and/or another server. Routing functions of the load balancer 116 can be configured directly or via a DNS. The load balancer 116 can coordinate requests from remote clients and can simplify client access by masking the internal configuration of the datacenter 106 from the remote clients.

In some implementations, the load balancer 116 can operate as a firewall, allowing or preventing communications based on configuration settings. Although the load balancer 116 is depicted in FIG. 1 as being within the datacenter 106, in some implementations, the load balancer 116 can instead be located outside of the datacenter 106, for example, when providing global routing for multiple datacenters. In some implementations, load balancers can be included both within and outside of the datacenter 106. In some implementations, the load balancer 116 can be omitted.

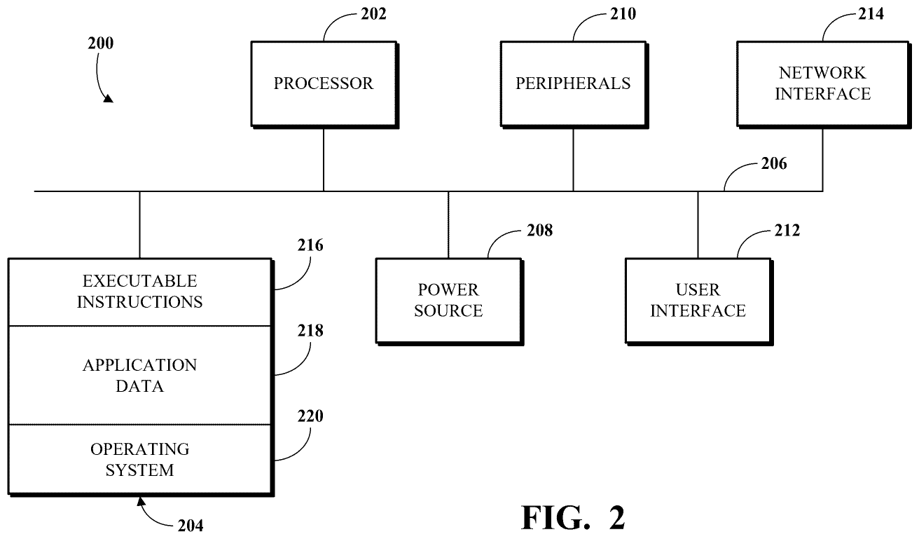

FIG. 2 is a block diagram of an example internal configuration of a computing device 200 of an electronic computing and communications system. In one configuration, the computing device 200 may implement one or more of the client 104A, the application server 108, the database server 110, or the telephony server 112 of the system 100 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a DRAM module, such as DDR SDRAM). In another example, the non-volatile memory of the memory 204 can be a disk drive, a solid state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220 can be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 214 provides a connection or link to a network (e.g., the network 114 shown in FIG. 1). The network interface 214 can be a wired network interface or a wireless network interface. The computing device 200 can communicate with other devices via the network interface 214 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

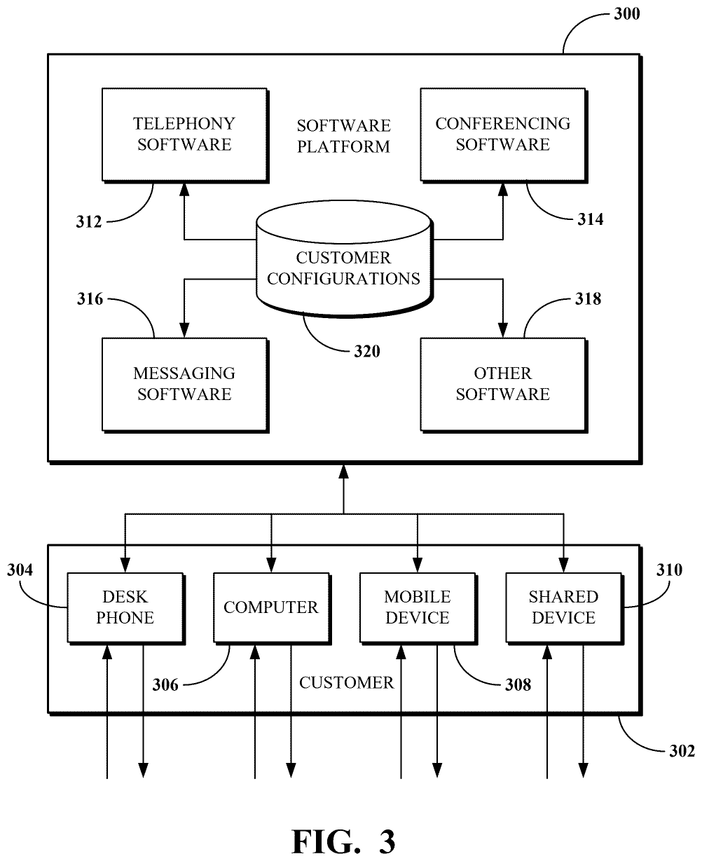

FIG. 3 is a block diagram of an example of a software platform 300 implemented by an electronic computing and communications system, for example, the system 100 shown in FIG. 1. The software platform 300 is a UCaaS platform accessible by clients of a customer of a UCaaS platform provider, for example, the clients 104A through 104B of the customer 102A or the clients 104C through 104D of the customer 102B shown in FIG. 1. The software platform 300 may be a multi-tenant platform instantiated using one or more servers at one or more datacenters including, for example, the application server 108, the database server 110, and the telephony server 112 of the datacenter 106 shown in FIG. 1.

The software platform 300 includes software services accessible using one or more clients. For example, a customer 302 as shown includes four clients-a client 304 (e.g., a desk phone), a client 306 (e.g., a computer), a client 308 (e.g., a mobile device), and a client 310 (e.g., a shared device). The desk phone is a desktop unit configured to at least send and receive calls and includes an input device for receiving a telephone number or extension to dial to and an output device for outputting audio and/or video for a call in progress. The computer is a desktop, laptop, or tablet computer including an input device for receiving some form of user input and an output device for outputting information in an audio and/or visual format. The mobile device is a smartphone, wearable device, or other mobile computing aspect including an input device for receiving some form of user input and an output device for outputting information in an audio and/or visual format. The desk phone, the computer, and the mobile device may generally be considered personal devices configured for use by a single user. The shared device is a desk phone, a computer, a mobile device, or a different device which may instead be configured for use by multiple specified or unspecified users.

Each of the clients 304 through 310 includes or runs on a computing device configured to access at least a portion of the software platform 300. In some implementations, the customer 302 may include additional clients not shown. For example, the customer 302 may include multiple clients of one or more client types (e.g., multiple desk phones or multiple computers) and/or one or more clients of a client type not shown in FIG. 3 (e.g., wearable devices or televisions other than as shared devices). For example, the customer 302 may have tens or hundreds of desk phones, computers, mobile devices, and/or shared devices.

The software services of the software platform 300 generally relate to communications tools but are in no way limited in scope. As shown, the software services of the software platform 300 include telephony software 312, conferencing software 314, messaging software 316, and other software 318. Some or all of the software 312 through 318 uses customer configurations 320 specific to the customer 302. The customer configurations 320 may, for example, be data stored within a database or other data store at a database server, such as the database server 110 shown in FIG. 1.

The telephony software 312 enables telephony traffic between ones of the clients 304 through 310 and other telephony-enabled devices, which may be other ones of the clients 304 through 310, other VOIP-enabled clients of the customer 302, non-VOIP-enabled devices of the customer 302, VOIP-enabled clients of another customer, non-VOIP-enabled devices of another customer, or other VOIP-enabled clients or non-VOIP-enabled devices. Calls sent or received using the telephony software 312 may, for example, be sent or received using the desk phone, a softphone running on the computer, a mobile application running on the mobile device, or using the shared device that includes telephony features.

The telephony software 312 further enables phones that do not include a client application to connect to other software services of the software platform 300. For example, the telephony software 312 may receive and process calls from phones not associated with the customer 302 to route that telephony traffic to one or more of the conferencing software 314, the messaging software 316, or the other software 318.

The conferencing software 314 enables audio, video, and/or other forms of conferences between multiple participants, such as to facilitate a conference between those participants. In some cases, the participants may all be physically present within a single location, for example, a conference room, in which the conferencing software 314 may facilitate a conference between only those participants and using one or more clients within the conference room. In some cases, one or more participants may be physically present within a single location and one or more other participants may be remote, in which the conferencing software 314 may facilitate a conference between all of those participants using one or more clients within the conference room and one or more remote clients. In some cases, the participants may all be remote, in which the conferencing software 314 may facilitate a conference between the participants using different clients for the participants. The conferencing software 314 can include functionality for hosting, presenting scheduling, joining, or otherwise participating in a conference. The conferencing software 314 may further include functionality for recording some or all of a conference and/or documenting a transcript for the conference.

The messaging software 316 enables instant messaging, unified messaging, and other types of messaging communications between multiple devices, such as to facilitate a chat or other virtual conversation between users of those devices. The unified messaging functionality of the messaging software 316 may, for example, refer to email messaging which includes a voicemail transcription service delivered in email format.

The other software 318 enables other functionality of the software platform 300. Examples of the other software 318 include, but are not limited to, device management software, resource provisioning and deployment software, administrative software, third party integration software, and the like. In one particular example, the other software 318 can include AR software such as, for example, an offline preparation component and/or an online processing component. In some such cases, the conferencing software 314 can include the other software 318.

The software 312 through 318 may be implemented using one or more servers, for example, of a datacenter such as the datacenter 106 shown in FIG. 1. For example, one or more of the software 312 through 318 may be implemented using an application server, a database server, and/or a telephony server, such as the servers 108 through 112 shown in FIG. 1. In another example, one or more of the software 312 through 318 may be implemented using servers not shown in FIG. 1, for example, a meeting server, a web server, or another server. In yet another example, one or more of the software 312 through 318 may be implemented using one or more of the servers 108 through 112 and one or more other servers. The software 312 through 318 may be implemented by different servers or by the same server.

Features of the software services of the software platform 300 may be integrated with one another to provide a unified experience for users. For example, the messaging software 316 may include a user interface element configured to initiate a call with another user of the customer 302. In another example, the telephony software 312 may include functionality for elevating a telephone call to a conference. In yet another example, the conferencing software 314 may include functionality for sending and receiving instant messages between participants and/or other users of the customer 302. In yet another example, the conferencing software 314 may include functionality for file sharing between participants and/or other users of the customer 302. In some implementations, some or all of the software 312 through 318 may be combined into a single software application run on clients of the customer, such as one or more of the clients 304 through 310.

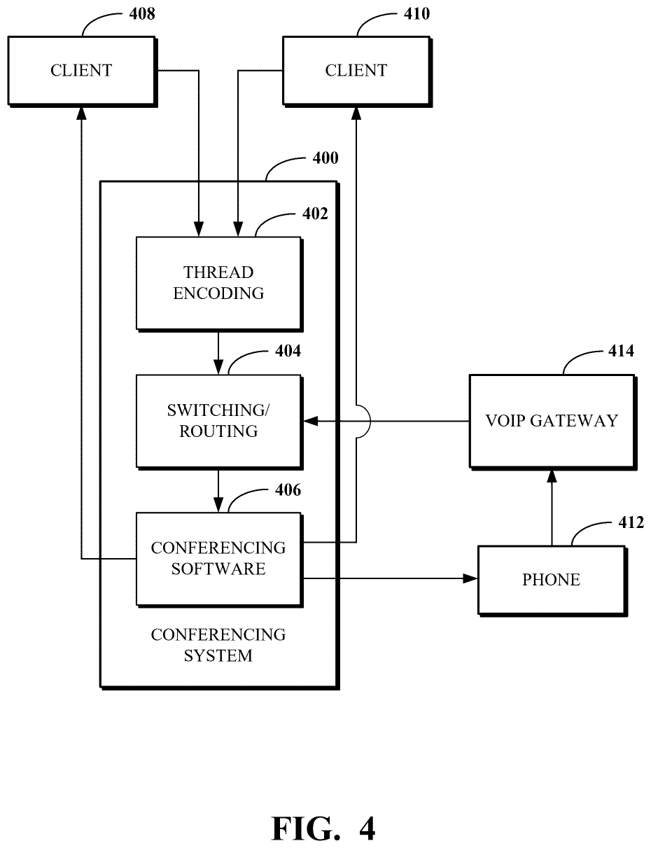

FIG. 4 is a block diagram of an example of a conferencing system 400 for delivering conferencing software services in an electronic computing and communications system, for example, the system 100 shown in FIG. 1. The conferencing system 400 includes a thread encoding tool 402, a switching/routing tool 404, and conferencing software 406. The conferencing software 406, which may, for example, the conferencing software 314 shown in FIG. 3, is software for implementing conferences (e.g., video conferences) between users of clients and/or phones, such as clients 408 and 410 and phone 412. For example, the clients 408 or 410 may each be one of the clients 304 through 310 shown in FIG. 3 that runs a client application associated with the conferencing software 406, and the phone 412 may be a telephone which does not run a client application associated with the conferencing software 406 or otherwise access a web application associated with the conferencing software 406. The conferencing system 400 may in at least some cases be implemented using one or more servers of the system 100, for example, the application server 108 shown in FIG. 1. Although two clients and a phone are shown in FIG. 4, other numbers of clients and/or other numbers of phones can connect to the conferencing system 400.

Implementing a conference includes transmitting and receiving video, audio, and/or other data between clients and/or phones, as applicable, of the conference participants. Each of the client 408, the client 410, and the phone 412 may connect through the conferencing system 400 using separate input streams to enable users thereof to participate in a conference together using the conferencing software 406. The various channels used for establishing connections between the clients 408 and 410 and the phone 412 may, for example, be based on the individual device capabilities of the clients 408 and 410 and the phone 412.

The conferencing software 406 includes a user interface tile for each input stream received and processed at the conferencing system 400. A user interface tile as used herein generally refers to a portion of a conferencing software user interface which displays information (e.g., a rendered video) associated with one or more conference participants. A user interface tile may, but need not, be generally rectangular. The size of a user interface tile may depend on one or more factors including the view style set for the conferencing software user interface at a given time and whether the one or more conference participants represented by the user interface tile are active speakers at a given time. The view style for the conferencing software user interface, which may be uniformly configured for all conference participants by a host of the subject conference or which may be individually configured by each conference participant, may be one of a gallery view in which all user interface tiles are similarly or identically sized and arranged in a generally grid layout or a speaker view in which one or more user interface tiles for active speakers are enlarged and arranged in a center position of the conferencing software user interface while the user interface tiles for other conference participants are reduced in size and arranged near an edge of the conferencing software user interface. In some cases, the view style or one or more other configurations related to the display of user interface tiles may be based on a type of video conference implemented using the conferencing software 406 (e.g., a participant-to-participant video conference, a contact center engagement video conference, or an online learning video conference, as will be described below).

The content of the user interface tile associated with a given participant may be dependent upon the source of the input stream for that participant. For example, where a participant accesses the conferencing software 406 from a client, such as the client 408 or 410, the user interface tile associated with that participant may include a video stream captured at the client and transmitted to the conferencing system 400, which is then transmitted from the conferencing system 400 to other clients for viewing by other participants (although the participant may optionally disable video features to suspend the video stream from being presented during some or all of the conference). In another example, where a participant access the conferencing software 406 from a phone, such as the phone 412, the user interface tile for the participant may be limited to a static image showing text (e.g., a name, telephone number, or other identifier associated with the participant or the phone 412) or other default background aspect since there is no video stream presented for that participant.

The thread encoding tool 402 receives video streams separately from the clients 408 and 410 and encodes those video streams using one or more transcoding tools, such as to produce variant streams at different resolutions. For example, a given video stream received from a client may be processed using multi-stream capabilities of the conferencing system 400 to result in multiple resolution versions of that video stream, including versions at 90p, 180p, 360p, 720p, and/or 1080p, amongst others. The video streams may be received from the clients over a network, for example, the network 114 shown in FIG. 1, or by a direct wired connection, such as using a universal serial bus (USB) connection or like coupling aspect. After the video streams are encoded, the switching/routing tool 404 direct the encoded streams through applicable network infrastructure and/or other hardware to deliver the encoded streams to the conferencing software 406. The conferencing software 406 transmits the encoded video streams to each connected client, such as the clients 408 and 410, which receive and decode the encoded video streams to output the video content thereof for display by video output components of the clients, such as within respective user interface tiles of a user interface of the conferencing software 406.

A user of the phone 412 participates in a conference using an audio-only connection and may be referred to an audio-only caller. To participate in the conference from the phone 412, an audio signal from the phone 412 is received and processed at a VOIP gateway 414 to prepare a digital telephony signal for processing at the conferencing system 400. The VOIP gateway 414 may be part of the system 100, for example, implemented at or in connection with a server of the datacenter 106, such as the telephony server 112 shown in FIG. 1. Alternatively, the VOIP gateway 414 may be located on the user-side, such as in a same location as the phone 412. The digital telephony signal is a packet switched signal transmitted to the switching/routing tool 404 for delivery to the conferencing software 406. The conferencing software 406 outputs an audio signal representing a combined audio capture for each participant of the conference for output by an audio output component of the phone 412. In some implementations, the VOIP gateway 414 may be omitted, for example, where the phone 412 is a VOIP-enabled phone.

A conference implemented using the conferencing software 406 may be referred to as a video conference in which video streaming is enabled for the conference participants thereof. The enabling of video streaming for a conference participant of a video conference does not require that the conference participant activate or otherwise use video functionality for participating in the video conference. For example, a conference may still be a video conference where none of the participants joining using clients turns on their video stream for any portion of the conference. In some cases, however, the conference may have video disabled, such as where each participant connects to the conference using a phone rather than a client, or where a host of the conference selectively configures the conference to exclude video functionality.

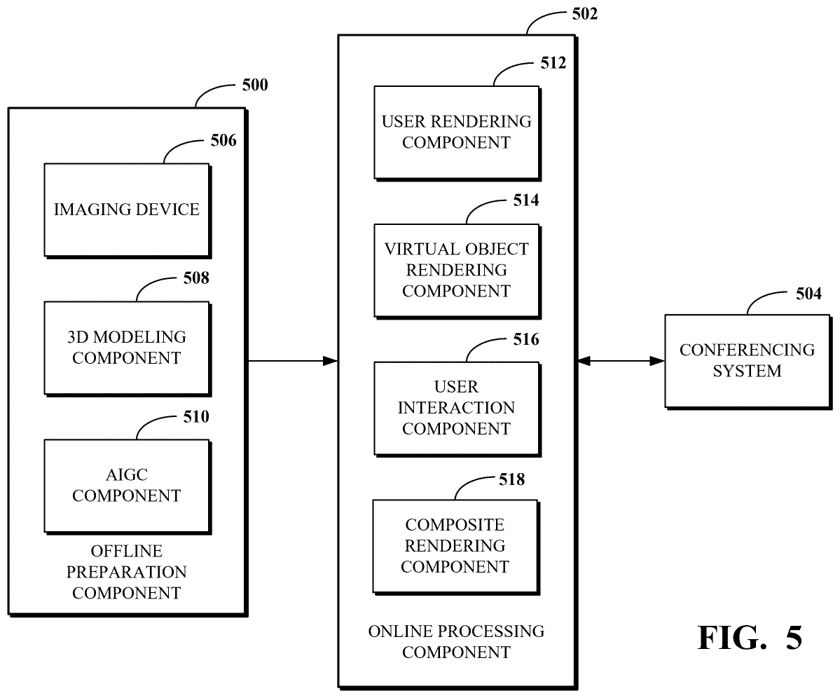

FIG. 5 is a block diagram of an example of an AR system for incorporating AR in a video conference. The AR system includes or otherwise uses an offline preparation component 500 and an online processing component 502. Together, the offline preparation component 500 and the online processing component 502 provide AR functionality to a conferencing system 504 for incorporation in video conferences. Any one or more aspects of the offline preparation component 500 and/or the online processing component 502 may be implemented on one or more computing devices (e.g., the computing device 200 shown in FIG. 2). The conferencing system 504 may be, be similar to, include, or be included in, the conferencing system 400 shown in FIG. 4. In some implementations, any two or more of the offline preparation component 500, the online processing component 502, and the conferencing system 504 may be integrated with one another.

As shown, the offline preparation component 500 may include an imaging device 506, a 3D modeling component 508, and an AIGC component 510. The imaging device 506, the 3D modeling component 508, and/or the AIGC component 510 may be implemented in a single device (e.g., a client 408 or a client 410 shown in FIG. 4, a client 306, a client 308, and/or a client 310 shown in FIG. 3) or in multiple devices.

The imaging device 506 may be any type of imaging device configured to obtain imaging information associated with an interaction space and/or an object. The imaging device 506 may be, be similar to, include, or be included in, a video camera installed in an interaction space (e.g., a conference room), a camera of a mobile device, and/or any other imaging device capable of obtaining imaging information of the interaction space. The imaging device may be a 3D imaging device, a 2D imaging device, a radio detection and ranging (radar) device, a light detection and ranging (LiDAR) device, and/or an ultrasound device, among other examples. In some implementations, the imaging device 506 may represent more than one imaging device and/or one or more type of imaging device.

The imaging information may include interaction space image information indicative of a physical interaction space. Interaction space image information may include any information about a physical environment such as a conference room, an office, or any other type of room, which may be used to generate a virtual representation thereof. For example, interaction space image information may include video data, digital image data, radar data, LiDAR data, and/or any other data indicative of one or more features of a physical environment such as a conference room.

The imaging information may include object image information indicative of a physical object. The physical object may be located within the interaction space or in another location. For example, the object image information may be obtained via the same imaging device 506 from which the interaction space image information is obtained and/or may be obtained from an additional imaging device 506. Object image information may include any information about a physical object that may be used to generate a virtual representation thereof (referred to as a “virtual object”).

The 3D modeling component 508 may include tools, such as programs, subprograms, functions, routines, subroutines, operations, executable instructions, and/or the like for generating 3D models. The 3D modeling component 508 may be configured to generate virtual interaction space image information corresponding to a virtual representation of an interaction space. For example, the 3D modeling component 508 may include one or more AI components configured to facilitate generation of the virtual interaction space information. The 3D modeling component 508 may obtain, via the imaging device 506, interaction space image information indicative of a physical interaction space. The 3D modeling component 508 may generate, based on the interaction space image information, virtual interaction space information corresponding to a virtual representation of the physical interaction space. The virtual representation may include a virtual 3D structure corresponding to the real physical 3D structure of the physical interaction space.

The 3D modeling component 508 may be configured to generate virtual object information for presenting a virtual object. In some implementations, the virtual object information may be a virtual representation of a physical object. For example, the 3D modeling component 508 may obtain object image information via the imaging device 506 and may generate the virtual object information based on the object image information. In some implementations, the virtual object information may be obtained via a content service such as a stock image distribution service, an internet search engine, and/or any other source of content.

In some implementations, the virtual object information may be obtained via the AIGC component 510. The AIGC component 510 may employ generative AI to generate the virtual object information. Generative AI refers to a class of algorithms that can create new content by learning patterns from existing data. These algorithms utilize deep learning techniques, such as neural networks, to generate outputs that can mimic the style, structure, and characteristics of the input data. Generative AI can produce a wide array of content types, including text, images, audio, and 3D models. Generative AI may be employed by the AIGC component 510 to generate virtual object information corresponding to 3D virtual objects that may be used for AR applications within a video conference environment. The AIGC component 510 may leverage generative AI models to analyze and interpret input data from various sources, including user interactions and environmental contexts, to create virtual objects that seamlessly integrate with the real-world environment displayed during the video conference. These virtual objects can be dynamically generated and manipulated in real-time, enhancing the interactive experience and providing participants with novel ways to communicate and collaborate. The AIGC component 510 may utilize advanced neural network architectures to ensure that the generated objects exhibit high fidelity and are contextually relevant, thereby improving the overall effectiveness and engagement of AR in video conferencing scenarios.

In some implementations, the 3D modeling component 508 may obtain a set of imaging device parameters associated with the imaging device 506 and may use the set of imaging device parameters to facilitate generation of the virtual room information and/or the virtual object information. For example, the set of imaging device parameters may include any one or more parameters associated with the operation of the imaging device 506, the location of the imaging device 506, the capabilities of the imaging device 506, and/or the position of the imaging device 506, among other examples. The imaging device parameters may include, for example, an imaging device position, an imaging device field of view, an imaging device zoom level, an imaging device location (e.g., relative to one or more other aspects of an interaction space and/or a geographic location), an imaging device exposure value, and/or any number of other parameters. The 3D modeling component 508 may use any number of different types of imaging algorithms, which may include AI techniques, to facilitate generating the virtual interaction space information and/or the virtual object information.

In some implementations, the 3D modeling component 508 may use the set of imaging device parameters to facilitate establishing a virtual location of the virtual object within a virtual representation (referred to as a “virtual interaction space”) of a physical interaction space. The 3D modeling component 508 may provide for output rendering information configured to cause a computing device to present, via a display device, a virtual representation of an interaction space and a virtual object. The rendering information may be configured to cause the computing device to display the virtual object based on the virtual 3D structure. The rendering information may be configured to cause the computing device to display the virtual object in a manner that makes the virtual object appear to interact with a virtual 3D structure of the virtual interaction space. For example, the virtual object may appear to sit on a table or a chair in the virtual interaction space.

During a video conference, the offline preparation component 500 may provide, to the online processing component 502, the virtual interaction space information, the virtual object information, and/or the rendering information. In some implementations, the online processing component 502 may be configured to generate the rendering information based on the virtual interaction space information and/or the virtual object information. As shown, the online processing component 502 may include a user rendering component 512, a virtual object rendering component 514, a user interaction component 516, and a composite rendering component 518. The user rendering component 512, the virtual object rendering component 514, the user interaction component 516, and/or the composite rendering component 518 may be implemented in a single device (e.g., the client 408 or the client 410 shown in FIG. 4, client 306, the client 308, and/or the client 310 shown in FIG. 3) or in multiple devices. The user rendering component 512, the virtual object rendering component 514, the user interaction component 516, and/or the composite rendering component 518 may include tools, such as programs, subprograms, functions, routines, subroutines, operations, executable instructions, and/or the like.

The user rendering component 512 may include hardware and/or software configured to generate user rendering information to facilitate rendering a virtual representation of a participant in a video conference. The user rendering component 512 may be configured to obtain video data from a video camera at the participant's location and may render the video data within a video conference user interface. The user rendering component 512 may be configured to obtain participant tracking information associated with a participant of the video conferencing platform. For example, the user rendering component 512 may be configured to obtain video data via an imaging device associated with the participant. The imaging device may be a conference room camera, a laptop camera, a mobile device camera, and/or any number of other types of imaging devices.

The user rendering component 512 may include software for generating a human analysis AI model based at least in part on the video data. For example, the user rendering component 512 may perform modeling (e.g., visual modeling, motion modeling, audio modeling, etc.) and/or motion tracking operations associated with perceptible qualities associated with a participant. This feature may require authorization of the participant, an account administrator, and/or another user prior to use. In some implementations, the user rendering component 512 may obtain video data associated with a participant and generate, based at least in part on the video data, user rendering information for rendering a 3D virtual participant depiction associated with a participant. The user rendering component 512 may provide the generated user rendering information to the composite rendering component 518.

The virtual object rendering component 514 is configured to generate data representations of virtual objects. For example, the virtual object rendering component 514 may be configured to obtain virtual object information and to generate virtual object rendering information based on the virtual object information. The virtual object rendering component 514 processes input parameters related to various virtual objects and produces corresponding rendering information. The generated virtual object information encompasses details such as position, orientation, scale, and texture attributes of the virtual objects. In some implementations, the virtual object rendering component 514 may be configured to obtain virtual object information from the 3D modeling component 508. In some implementations, the virtual object rendering component 514 may be configured to obtain virtual object information from the AIGC component 510. In some implementations, the virtual object rendering component 514 may be configured to obtain virtual object information from a content service such as a stock image distribution service, an internet search engine, and/or any other source of content. Once created, this information is transferred to the composite rendering component 518, where it is integrated with additional visual data to produce a final rendered scene.

The user interaction component 516 may include hardware and/or software configured to generate user interaction information to facilitate participant interaction with one or more features of a video conference. Overall, the user interaction component 516 may enhance the interactive experience within virtual interaction spaces by enabling intuitive and responsive manipulation of virtual objects, thereby fostering a more engaging and immersive AR conferencing experience.

For example, the user interaction component 516 may be configured to generate user interaction information to facilitate manipulation, by a participant, of virtual objects in a video conference. The user interaction component 516 may include hardware and software elements designed to detect, interpret, and respond to user inputs, thereby enabling dynamic manipulation and engagement with virtual objects during a video conference. The user interaction component 516 may include gesture recognition capabilities which detect and interpret participant gestures using data obtained from an imaging device. These gestures can be used to select, move, rotate, or trigger effects on virtual objects presented within the virtual representation of the physical conference room. For example, a participant may employ specific hand signals to reposition a virtual object, change its orientation, or initiate an animation sequence associated with the object. The user interaction component 516 may employ AI techniques, incorporating machine learning models to enhance the accuracy and responsiveness of gesture recognition. The AI techniques may include real-time processing of video data to track hand movements, identify key gesture patterns, and translate these patterns into corresponding virtual object manipulations. In some implementations, the AI models may be trained using a dataset of common gestures to ensure robust interaction capabilities.

In addition to gesture recognition, the user interaction component 516 may support other forms of user input such as touch-based interactions, voice commands, and click events. For instance, a touch interface could allow participants to interact with virtual objects via swiping, pinching, or tapping gestures on a touchscreen device. Similarly, voice recognition technology can enable participants to issue verbal commands to manipulate virtual objects, enhancing the accessibility and ease of use of the system.

The user interaction component 516 may be configured to manage and synchronize interactions among multiple participants. For example, the user interaction component 516 may include a coordination mechanism to handle input from different participants, ensuring that changes made by one participant are accurately reflected in the virtual representation for all participants. The coordination mechanism may also implement rules to manage concurrent interactions, such as prioritizing inputs based on predefined criteria or user roles.

The user interaction component 516 may interface with the composite rendering component 518 to ensure that user interactions are seamlessly integrated into the rendered virtual environment. When a user interaction, such as a detected gesture or voice command, is identified and processed, the user interaction component 516 may generate corresponding interaction data. This data may then be provided to the composite rendering component 518, which may update the visual presentation of the virtual conference environment accordingly.

The user interaction component 516 may be configured to generate user interaction information to facilitate adjustment, by a participant, of one or more display parameters, communication parameters, and/or any other adjustable feature of a video conference. The user interaction component 516 may be configured to obtain user interaction information associated with a participant of the video conferencing platform. In another example, the user interaction component 516 may be configured to generate user interaction information to facilitate rendering a virtual representation of a participant in a video conference. The virtual representation of the participant may be a video image of the participant or a 3D virtual participant depiction of the participant. In some implementations, the user interaction component 516 may obtain video data associated with a participant and generate, based at least in part on the video data, user rendering information for rendering a 3D virtual participant depiction associated with the participant.

To generate user interaction information, the user interaction component 516 may be configured to obtain video data via an imaging device associated with the participant. The imaging device may be a conference room camera, a laptop camera, a mobile device camera, and/or any number of other types of imaging devices. The user interaction component 516 may include software for generating an AI model based at least in part on the video data. The AI model may be user interaction information and/or may be used to generate user interaction information. For example, the user interaction component 516 may perform modeling (e.g., visual modeling, motion modeling, audio modeling, etc.) and/or motion tracking operations associated with perceptible qualities associated with a participant. This feature may require authorization of the participant, an account administrator, and/or another user prior to use. The user interaction component 516 may provide the generated user interaction information to the composite rendering component 518.

The composite rendering component 518 may include hardware and/or software configured to generate composite rendering information to facilitate rendering any number of different aspects of a video conference. The composite rendering component 518 may be configured to obtain user rendering information from the user rendering component 512, virtual object rendering information from the virtual object rendering component 514, and user interaction information from the user interaction component 516. The composite rendering component 518 may be configured to generate composite rendering information based on the user rendering information, the virtual object rendering information, and/or the user interaction information. The composite rendering information may be configured to cause a computing device to present, via a display device, a virtual representation of a 3D interaction space and a virtual object. The rendering information may be configured to cause the computing device to display the virtual object based on the virtual 3D structure. The rendering information may be configured to cause the computing device to display the virtual object in a manner that makes the virtual object appear to interact with a virtual 3D structure of the virtual interaction space.

The composite rendering component 518 may include hardware and/or software elements configured to manage and process diverse rendering inputs. This processing may enable the accurate integration of participant representations, virtual objects, and real-time interactions within a virtual 3D structure that mirrors the 3D interaction space. For example, the user rendering information may include video streams and 3D virtual participant depiction information generated based on modeling and/or motion tracking operations associated with perceptible qualities associated with a participant, while virtual object rendering information may include details such as the position, orientation, texture, and animation of virtual objects. To seamlessly integrate these disparate data sources, the composite rendering component 518 may implement rendering algorithms that ensure that the spatial relationships between virtual objects and the virtual representation of 3D interaction space are accurately maintained. Additionally, the composite rendering component 518 may support real-time adjustments, allowing for smooth transitions and interactions as participants manipulate virtual objects through gestures, clicks, or voice commands.

The composite rendering component 518 interfaces with the user interaction component 516 to apply interaction data, such as gesture indications or voice command inputs, to the rendering process. This interaction data triggers corresponding visual updates, ensuring that changes made by participants are promptly reflected in the virtual conference environment. For instance, when a participant performs a gesture to rotate a virtual object, the composite rendering component updates the object's orientation in real-time, providing an immediate visual response.

In some implementations, the composite rendering component 518 may include synchronization mechanisms that coordinate rendering activities across multiple user devices. The synchronization mechanisms may facilitate ensuring consistency in the presentation of the virtual environment for all conference participants, regardless of the device or platform they are using. By maintaining synchronized states of virtual objects and representations of participants (e.g., 3D virtual participant depictions), the composite rendering component 518 may enhance the collaborative experience, enabling participants to interact with each other and the virtual environment as though they were physically co-located.

The conferencing system 504 interfaces with the offline preparation component 500 and the online processing component 502 to facilitate the production of an immersive and interactive 3D conferencing experience incorporating AR features. The offline preparation component 500 captures and processes data from the physical environment, generating the foundational elements required for the 3D experience. Subsequently, the online processing component 502 manages real-time data transmission and rendering, allowing dynamic interaction within the 3D space. The conferencing system 504 orchestrates the synchronization and integration of these components, ensuring a seamless transition from offline environment capture to online interactive rendering, thereby producing a cohesive and engaging 3D conferencing experience.

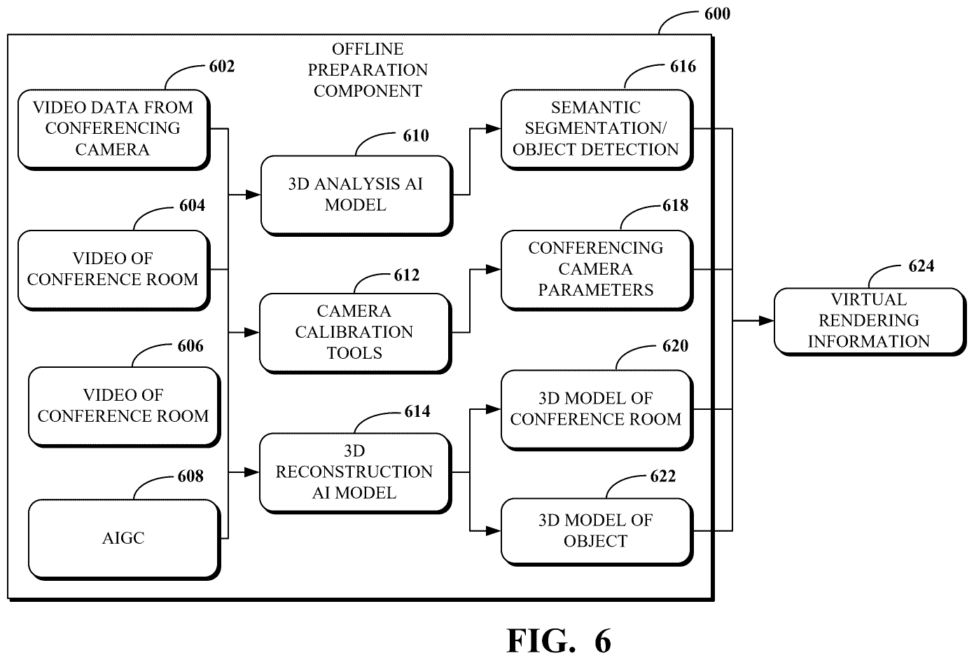

FIG. 6 is a schematic block diagram illustrating an example of an offline preparation process for implementing AR in connection with a conferencing system. The process may be performed by an offline preparation component 600. The offline preparation component 600 may be, be similar to, include, or be included in, the offline preparation component 500 shown in FIG. 5. The offline preparation component 600 may be configured to generate a virtual representation of a 3D interaction space that forms the basis of an AR video conferencing experience.

The offline preparation component 600 may receive video data 602 captured by a conferencing camera. The conferencing camera may be any type of video camera suitable for capturing video footage of a 3D interaction space (e.g., a conference room or an office), such as fixed-position cameras installed in the conference room or mobile cameras, including cell phone cameras. The captured video data 602 serves as input for the offline preparation component 600. The offline preparation component 600 may receive video data 604 associated with a conference room (or other 3D interaction space), capturing the overall environment and spatial dynamics of the room. The offline preparation component 600 may receive video data 606 associated with one or more objects. The video data 606 may include information associated with specific objects within or outside the conference room that are to be integrated into the virtual interaction space. Additionally, the offline preparation component 600 may receive AIGC 608, which may include AI-generated virtual objects. The virtual objects may be generated using generative AI techniques, creating new virtual objects based on learned patterns from existing data.

The video data 602, the video data 604, the video data 606, and/or the AIGC 608 may be processed by a 3D analysis AI model 610. The 3D analysis AI model 610 may perform any number of functions, including the identification and management of objects within the scene. For instance, it may recognize extraneous items, such as a misplaced chair, and exclude them from the virtual interaction space. The 3D analysis AI model 610 may analyze spatial relationships and dimensions, forming a detailed understanding of the structure of the interaction space and the locations of objects therein.

The offline preparation component 600 may include a set of camera calibration tools 612 that may be hardware and/or software employed to perform camera calibration, which may be used to facilitate accurate 3D modeling. For example, the offline preparation component 600 may obtain intrinsic parameters like focal length and lens distortion, and extrinsic parameters like the camera's position and orientation relative to the conference room. The video data 602, the video data 604, the video data 606, and/or the AIGC 608 may be processed by the camera calibration tools 612 and/or may be used for calibration by the camera calibration tools 612. By calibrating the camera, the offline preparation component 600 may ensure that virtual objects will align correctly with the real-world environment.

The video data 602, the video data 604, the video data 606, and/or the AIGC 608 may be processed by a 3D reconstruction AI model 614. The 3D reconstruction AI model 614 may use the analyzed video data 602, 604, and/or 606 to reconstruct a detailed 3D model 620 of the interaction space and a detailed 3D model 622 of the virtual objects.

The video data 602, the video data 604, the video data 606, and/or the AIGC 608 may be processed using one or more semantic segmentation and object detection processes 616, which may categorize different features within the scene. For instance, the offline preparation component 600 may detect tables, chairs, and screens and segment these objects for accurate representation within the virtual environment and/or removal from the virtual environment.

A set of conferencing camera parameters 618 may be derived from the camera calibration tools 612. The conferencing camera parameters 618 parameters may be used to ensure that all virtual objects and interaction space dimensions are aligned correctly with the actual physical setup. The calibration parameters include details about the camera's intrinsic attributes, such as aperture and focal depth, as well as extrinsic attributes like positioning and angle relative to the interaction space.

The room and objects identified through the 3D analysis and semantic segmentation may be reconstructed into a 3D model 620 of the interaction space and a 3D model 622 of one of one or more objects. The 3D model 620 of the interaction space includes spatial and structural details captured from the video data 602 and/or the video data 604. The 3D model 622 may be used for replicating the specific characteristics and dimensions of individual objects that may be interacted with during the video conference.

As shown, the offline preparation component 600 generates virtual rendering information 624. This information includes data that is used for rendering virtual objects accurately within the virtual interaction space during an online conference. The virtual rendering information 624 may be configured to ensure that virtual objects are projected correctly with respect to geometric and visual perspectives, providing a seamless and realistic AR experience. For example, the virtual rendering information 624 may include shadow rendering, ensuring that virtual objects cast realistic shadows in the virtual interaction space, and occlusion processing, enabling virtual objects to appear in front of or behind physical objects based on their positions.

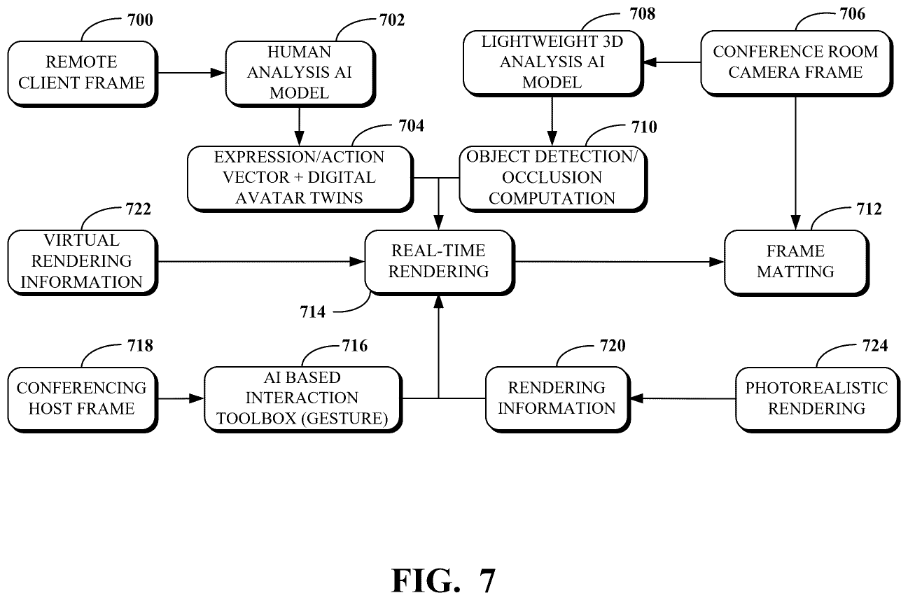

FIG. 7 is a schematic block diagram illustrating an example of an online process for implementing AR in connection with a conferencing system. The online process may be implemented using an online processing component such as, for example, the online processing component 502 shown in FIG. 5.

The remote client frame 700 captures the user data which is then processed by human analysis AI model 702. The human analysis AI model 702 may generate user interaction information 704, which may include, for example, expression vectors, action vectors, and/or 3D virtual participant depiction information, which may be utilized for creating and animating a 3D virtual participant depiction associated with a participant.

The conference room camera frame 706 gathers contextual data from the interaction space. This data may be analyzed by a lightweight 3D analysis AI model 708, which may be used to facilitate an object detection and/or occlusion computation 710. The results of this analysis may be used for accurately integrating virtual elements into the real-world context captured by the conference room camera.

In some implementations, a frame matting component 712 may receive inputs from the conference room camera frame 706 and may use frame matting techniques to distinguish between foreground and background elements. This processed information may be fed into a real-time rendering process 714, which may consolidate various inputs to generate the AR environment.

An AI-based interaction toolbox 716 may permit participants to interact with the virtual elements using hand gestures, enhancing interactivity. A conferencing host frame 718 may be used for managing the overall session, while virtual rendering information 720 provides data for creating virtual elements. Rendering information 720 and virtual rendering information 722 may be used in conjunction with the real-time rendering process 714 to produce the final visual output. This information may facilitate maintaining high-quality visual fidelity. A photorealistic rendering component 724 may employ advanced rendering techniques to enhance the realism of virtual elements, ensuring they seamlessly blend with the real-world background.

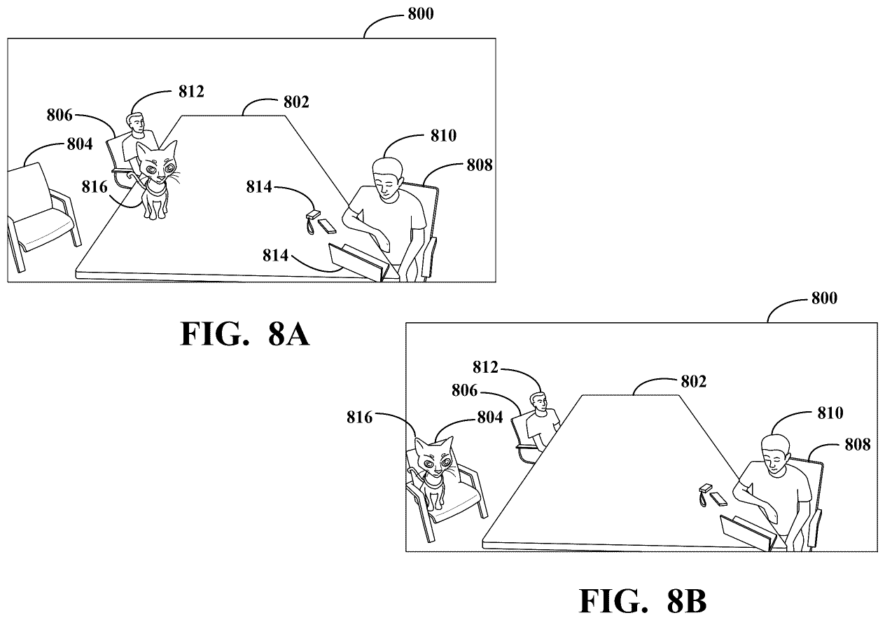

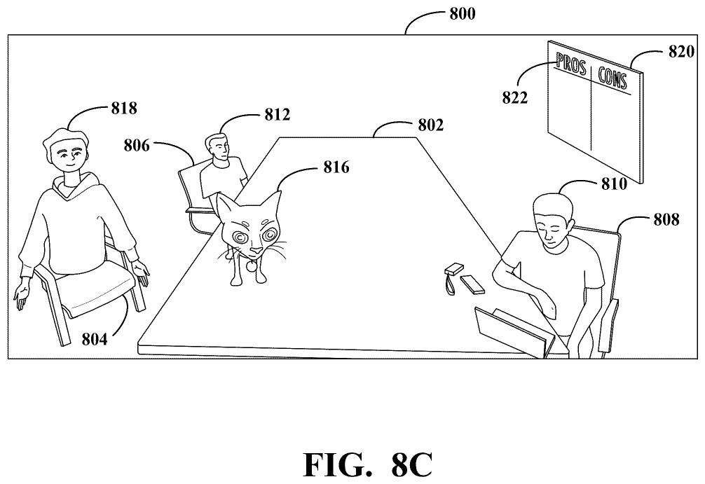

FIGS. 8A-8C are diagrams illustrating an example of a virtual interaction space 800. The virtual interaction space 800 may be a representation of a 3D interaction space such as, for example, a conference room. The virtual interaction space 800 includes a virtual table 802 at the center of the scene. The virtual table 802 may be, for example, a rendered video image of a table in the corresponding 3D interaction space. Arranged around the virtual table 802 are virtual chairs 804, 806, and 808. The virtual chairs 804, 806, and 808 may be rendered video images of chairs located in the 3D interaction space. In some implementations, the virtual table 802, the virtual chair 804, the virtual chair 806, and/or the virtual chair 808 may be virtual objects displayed in the virtual interaction space 800 but not appearing in the corresponding 3D interaction space.

In FIG. 8A, a video representation 810 of a participant is shown as being seated in the virtual chair 808. A 3D virtual participant depiction 812 is shown as being seated in the virtual chair 806. In FIG. 8A, the video representation 810 of the participant is depicted interacting with some virtual objects 814 on the virtual table 802, indicating engagement within the virtual interaction space 800. This interaction underlines the collaborative and social aspects of the virtual environment. FIG. 8A also shows a virtual object 816 (in this case, a virtual cat) sitting on the virtual table 802.

FIG. 8B shows another perspective of the virtual interaction space 800, in which the virtual object 816 has been relocated to the virtual chair 804. The relocation of the virtual object 816 may be performed, for example, in response to receiving a user input (e.g., a gesture) that is interpreted as an instruction to relocate the virtual object 816.

FIG. 8C introduces more elements to the virtual interaction space 800. For example, an additional 3D virtual participant depiction 818 has been placed in the scene and is shown as being seated in the virtual chair 804. The virtual object 816 has been relocated back to the virtual table 802. A wall-mounted virtual white board 820 is shown as being attached to a wall of the virtual interaction space 800. The virtual white board 820 may be interacted with by users (e.g., participants in the video conference). For example, participants may be able to interact with content 822 shown as being written on the virtual white board. The user interaction with the content 822 may include adding to the content 822, selecting the content 822, removing the content 822, editing the content 822, and/or the like. The inclusion of the virtual white board 820 also may facilitate an enhanced interactive capability beyond typical real-time communication, extending to collaborative decision-making and idea sharing.

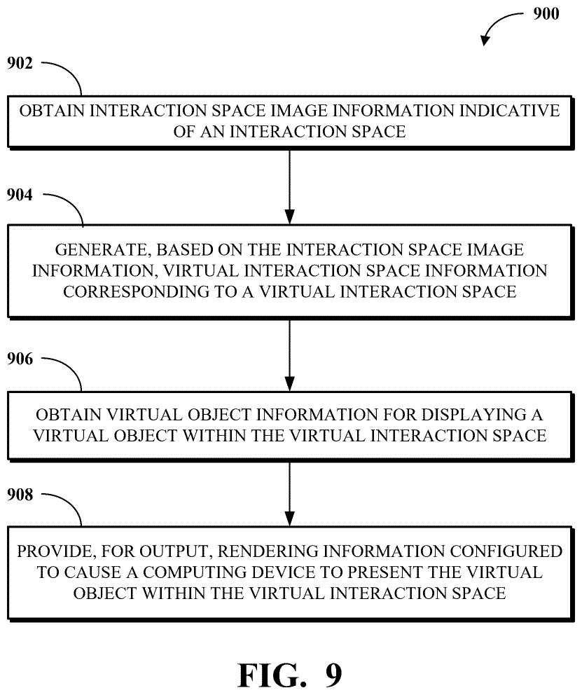

To further describe some implementations in greater detail, reference is next made to examples of techniques which may be performed by or using a system for implementing AR in connection with a video conferencing platform. FIG. 9 is a flowchart of an example of a technique 900 for implementing AR in connection with a video conferencing platform. The technique 900 can be executed using computing devices, such as the systems, hardware, and software described with respect to FIGS. 1-8C. The technique 900 can be performed, for example, by executing a machine-readable program or other computer-executable instructions, such as routines, instructions, programs, or other code. The steps, or operations, of the technique 900, or another technique, method, process, or algorithm described in connection with the implementations disclosed herein can be implemented directly in hardware, firmware, software executed by hardware, circuitry, or a combination thereof. For example, one or more aspects of the technique 900 may be performed by the offline preparation component 500 shown in FIG. 5, the online processing component 502 shown in FIG. 5, the conferencing system 504 shown in FIG. 5, the conferencing system 400 shown in FIG. 4, the client 408 and/or the client 410 shown in FIG. 4, the software platform 300 shown in FIG. 3, the client 306 shown in FIG. 3, the client 308 shown in FIG. 3, the client 310 shown in FIG. 3, the computing device 200 shown in FIG. 2, and/or one or more aspects of the system 100 shown in FIG. 1, among other examples.

For simplicity of explanation, the technique 900 is depicted and described herein as a series of steps or operations. However, the steps or operations of the technique 900 in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The step 902 includes obtaining interaction space image information indicative of an interaction space. The interaction space image information may be obtained via an imaging device.

The step 904 includes generating virtual interaction space information corresponding to a virtual interaction space associated with a video conference, the virtual interaction space comprising a virtual 3D structure representing the interaction space.

The step 906 includes obtaining virtual object information for displaying a virtual object within the virtual interaction space. In some implementations, obtaining the virtual object information comprises obtaining the virtual object information via at least one of the imaging device or an additional imaging device, the virtual object comprising a virtual representation of a physical object. In some implementations, obtaining the virtual object information comprises obtaining the virtual object information via a content service. In some implementations, obtaining the virtual object information comprises obtaining the virtual object information via an artificial intelligence content generation system.

The step 908 includes providing, for output and based on the virtual interaction space information and the virtual object information, rendering information configured to cause a computing device to present, via a display device, the virtual object within the virtual interaction space.

In some implementations, the technique 900 further includes obtaining a gesture indication indicative of detection, in user image information associated with the video conference, of a hand gesture made by a participant; and providing, for output and based on the gesture indication, additional rendering information configured to cause the computing device to present, via the display device, a modification of the virtual object. In some implementations, the technique 900 further includes obtaining an indication of a request, from a participant, to display a 3D virtual participant depiction within the virtual interaction space; and providing, for output and based on the indication, additional rendering information (e.g., user rendering information) configured to cause the computing device to present, via the display device, the 3D virtual participant depiction within the virtual interaction space, wherein the 3D virtual participant depiction comprises a 3D representation of the participant. In some implementations, the technique 900 further includes obtaining an indication of a request, from a participant, to display a 3D virtual participant depiction within the virtual interaction space; and providing, for output and based on the indication, additional rendering information (e.g., user rendering information) configured to cause the computing device to present, via the display device, the 3D virtual participant depiction in a virtual location within the virtual representation of the interaction space based on a location of the participant. In some implementations, providing the additional rendering information may include providing the additional rendering information configured to cause the computing device to present, via the display device, the 3D virtual participant depiction in a virtual pose within the virtual interaction space based on a pose of the participant.

In some implementations, the technique 900 further includes obtaining an indication of a request, from a participant, to display a 3D virtual participant depiction within the virtual interaction space; and providing, for output and based on the indication, additional rendering information (e.g., user rendering information) configured to cause the computing device to present, via the display device, the 3D virtual participant depiction as having a virtual facial expression within the interaction space based on a facial expression of the participant.

In some implementations, the technique 900 further includes obtaining an indication of a request, from a participant, to display a 3D virtual participant depiction within the virtual interaction space; and providing, for output and based on the indication, additional rendering information (e.g., user rendering information) configured to cause the computing device to present, via the display device, the 3D virtual participant depiction within the virtual interaction space, wherein the 3D virtual participant depiction comprises a 3D representation of the participant, wherein providing the additional rendering information comprises providing the additional rendering information configured to cause the computing device to present a virtual action performed by the 3D virtual participant depiction within the virtual interaction space based on an action of the participant.

In some implementations, the technique 900 further includes providing for output additional rendering information configured to cause the computing device to present an additional virtual object within the virtual interaction space, where the additional virtual object is configured to occlude at least a portion of the virtual object. In some implementations, the technique 900 further includes additional rendering information configured to cause the computing device to present, via the display device, the additional virtual object within the virtual interaction space, where the additional virtual object is configured to interact with the virtual object.

Some implementations include a method, comprising: obtaining, via an imaging device, interaction space image information indicative of an interaction space; generating, based on the interaction space image information, virtual interaction space information corresponding to a virtual interaction space associated with a video conference, the virtual interaction space comprising a virtual 3D structure representing the interaction space; obtaining virtual object information for displaying a virtual object within the virtual interaction space; and providing, for output and based on the virtual interaction space information and the virtual object information, rendering information configured to cause a computing device to present, via a display device, the virtual object within the virtual interaction space.

In some implementations, obtaining the virtual object information comprises obtaining the virtual object information via at least one of the imaging device or an additional imaging device, the virtual object comprising a virtual representation of a physical object.

In some implementations, obtaining the virtual object information comprises obtaining the virtual object information via a content service.

In some implementations, obtaining the virtual object information comprises obtaining the virtual object information via an artificial intelligence content generation system.

In some implementations, the method further comprises: obtaining a gesture indication indicative of detection, in user image information associated with the video conference, of a hand gesture made by a participant; and providing, for output and based on the gesture indication, additional rendering information configured to cause the computing device to present, via the display device, a modification of the virtual object.

In some implementations, the method further comprises: obtaining an indication of a request, from a participant, to display a 3D virtual participant depiction within the virtual interaction space; and providing, for output and based on the indication, additional rendering information configured to cause the computing device to present, via the display device, the 3D virtual participant depiction within the virtual interaction space, wherein the 3D virtual participant depiction comprises a 3D representation of the participant.

In some implementations, the method further comprises: obtaining an indication of a request, from a participant, to display a 3D virtual participant depiction within the virtual interaction space; and providing, for output and based on the indication, additional rendering information configured to cause the computing device to present, via the display device, the 3D virtual participant depiction within the virtual interaction space, wherein the 3D virtual participant depiction comprises a 3D representation of the participant, wherein providing the additional rendering information comprises providing the additional rendering information configured to cause the computing device to present the 3D virtual participant depiction in a virtual location within the virtual interaction space based on a location of the participant.

In some implementations, the method further comprises: obtaining an indication of a request, from a participant, to display a 3D virtual participant depiction within the virtual interaction space; and providing, for output and based on the indication, additional rendering information configured to cause the computing device to present, via the display device, the 3D virtual participant depiction within the virtual interaction space, wherein the 3D virtual participant depiction comprises a 3D representation of the participant, wherein providing the additional rendering information comprises providing the additional rendering information configured to cause the computing device to present the 3D virtual participant depiction in a virtual pose based on a pose of the participant.

In some implementations, the method further comprises: obtaining an indication of a request, from a participant, to display a 3D virtual participant depiction within the virtual interaction space; and providing, for output and based on the indication, additional rendering information configured to cause the computing device to present, via the display device, the 3D virtual participant depiction within the interaction space, wherein the 3D virtual participant depiction comprises a 3D representation of the participant, wherein providing the additional rendering information comprises providing the additional rendering information configured to cause the computing device to present the 3D virtual participant depiction as having a virtual facial expression based on a facial expression of the participant.

In some implementations, the method further comprises: obtaining an indication of a request, from a participant, to display a 3D virtual participant depiction within the virtual interaction space; and providing, for output and based on the indication, additional rendering information configured to cause the computing device to present, via the display device, the 3D virtual participant depiction within the virtual interaction space, wherein the 3D virtual participant depiction comprises a 3D representation of the participant, wherein providing the additional rendering information comprises providing the additional rendering information configured to cause the computing device to present a virtual action performed by the 3D virtual participant depiction based on an action performed by the participant.

Some implementations include a non-transitory computer-readable medium storing instructions operable to cause one or more processors to perform operations comprising: obtaining, via an imaging device, interaction space image information indicative of an interaction space; generating, based on the interaction space image information, virtual interaction space information corresponding to a virtual interaction space associated with a video conference, the virtual interaction space comprising a virtual 3D structure representing the interaction space; obtaining virtual object information for displaying a virtual object within the virtual interaction space; and providing, for output and based on the virtual interaction space information and the virtual object information, rendering information configured to cause a computing device to present, via a display device, the virtual object within the virtual interaction space.

In some implementations, the virtual object comprises a virtual representation of a white board.

In some implementations, the virtual object comprises a virtual representation of a white board, and wherein the virtual representation of the white board is configured to be manipulated by a user via an input device of the computing device.

In some implementations, the virtual object comprises a virtual representation of a physical object.

In some implementations, the virtual object information comprises content provided by a content service.

In some implementations, the virtual object information comprises artificial intelligence generated content.

In some implementations, the operations further comprise: obtaining a gesture indication indicative of detection, in user image information associated with the video conference, of a hand gesture made by a participant; and providing, for output and based on the gesture indication, additional rendering information configured to cause the computing device to present, via the display device, a modification of a virtual position of the virtual object.

Some implementations include a system, comprising: one or more memories; and one or more processors configured to execute instructions stored in the one or more memories to: obtain, via an imaging device, interaction space image information indicative of an interaction space; generate, based on the interaction space image information, virtual interaction space information corresponding to a virtual interaction space associated with a video conference, the virtual interaction space comprising a virtual 3D structure representing the interaction space; obtain virtual object information for displaying a virtual object within the virtual interaction space; and provide for output rendering information configured to cause a computing device to present, via a display device and based on the virtual 3D structure, the virtual object within the virtual interaction space.

In some implementations, the one or more processors are further configured to execute the instructions stored in the one or more memories to: obtain an indication of a request, from a participant, to display a 3D virtual participant depiction within the virtual interaction space; and provide, for output and based on the indication, additional rendering information configured to cause the computing device to present, via the display device, the 3D virtual participant depiction within the virtual interaction space, wherein the 3D virtual participant depiction comprises a 3D representation of the participant.

In some implementations, the one or more processors are further configured to provide for output additional rendering information configured to cause the computing device to present an additional virtual object within the virtual interaction space, wherein the additional virtual object is configured to interact with the virtual object.

As used herein, unless explicitly stated otherwise, any term specified in the singular may include its plural version. For example, “a computer that stores data and runs software,” may include a single computer that stores data and runs software or two computers—a first computer that stores data and a second computer that runs software. Also “a computer that stores data and runs software,” may include multiple computers that together stored data and run software. At least one of the multiple computers stores data, and at least one of the multiple computers runs software.

As used herein, the term “computer-readable medium” encompasses one or more computer readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

As used herein, the term “memory subsystem” includes one or more memories, where each memory may be a computer-readable medium. A memory subsystem may encompass memory hardware units (e.g., a hard drive or a disk) that store data or instructions in software form. Alternatively, or in addition, the memory subsystem may include data or instructions that are hard-wired into processing circuitry.

As used herein, processing circuitry includes one or more processors. The one or more processors may be arranged in one or more processing units, for example, a central processing unit (CPU), a graphics processing unit (GPU), or a combination of at least one of a CPU or a GPU.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory subsystem and hardware that is hard-wired into the processing circuitry.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

1. A method, comprising:
obtaining, via an imaging device, interaction space image information indicative of an interaction space;
generating, based on the interaction space image information, virtual interaction space information corresponding to a virtual interaction space associated with a video conference, the virtual interaction space comprising a virtual three-dimensional (3D) structure representing the interaction space;
obtaining, via an artificial intelligence content generation (AICG) system, virtual object information for displaying a virtual object within the virtual interaction space, wherein the virtual object information comprises new content generated by the AICG system based on input data associated with user interactions and environmental contexts; and
providing, for output and based on the virtual interaction space information and the virtual object information, rendering information configured to cause a computing device to present, via a display device, the virtual object within the virtual interaction space.

2. The method of claim 1, wherein obtaining the virtual object information comprises:
obtaining the virtual object information via at least one of the imaging device or an additional imaging device, the virtual object comprising a virtual representation of a physical object.

3. The method of claim 1, wherein obtaining the virtual object information comprises:
obtaining the virtual object information via a content service.

4. The method of claim 1, further comprising:
obtaining, from a plurality of users, a plurality of concurrent user inputs indicative of user interaction with a virtual object; and
prioritizing the plurality of concurrent user inputs based on at least one of predefined criteria or a user.

5. The method of claim 1, further comprising:
obtaining a gesture indication indicative of detection, in user image information associated with the video conference, of a hand gesture made by a participant; and
providing, for output and based on the gesture indication, additional rendering information configured to cause the computing device to present, via the display device, a modification of the virtual object.

6. The method of claim 1, further comprising:
obtaining an indication of a request, from a participant, to display a 3D virtual participant depiction within the virtual interaction space; and
providing, for output and based on the indication, additional rendering information configured to cause the computing device to present, via the display device, the 3D virtual participant depiction within the virtual interaction space, wherein the 3D virtual participant depiction comprises a 3D representation of the participant.

7. The method of claim 1, further comprising:
obtaining an indication of a request, from a participant, to display a 3D virtual participant depiction within the virtual interaction space; and
providing, for output and based on the indication, additional rendering information configured to cause the computing device to present, via the display device, the 3D virtual participant depiction within the virtual interaction space, wherein the 3D virtual participant depiction comprises a 3D representation of the participant, wherein providing the additional rendering information comprises providing the additional rendering information configured to cause the computing device to present the 3D virtual participant depiction in a virtual location within the virtual interaction space based on a location of the participant.

8. The method of claim 1, further comprising:
obtaining an indication of a request, from a participant, to display a 3D virtual participant depiction within the virtual interaction space; and
providing, for output and based on the indication, additional rendering information configured to cause the computing device to present, via the display device, the 3D virtual participant depiction within the virtual interaction space, wherein the 3D virtual participant depiction comprises a 3D representation of the participant, wherein providing the additional rendering information comprises providing the additional rendering information configured to cause the computing device to present the 3D virtual participant depiction in a virtual pose based on a pose of the participant.

9. The method of claim 1, further comprising:
obtaining an indication of a request, from a participant, to display a 3D virtual participant depiction within the virtual interaction space; and
providing, for output and based on the indication, additional rendering information configured to cause the computing device to present, via the display device, the 3D virtual participant depiction within the interaction space, wherein the 3D virtual participant depiction comprises a 3D representation of the participant, wherein providing the additional rendering information comprises providing the additional rendering information configured to cause the computing device to present the 3D virtual participant depiction as having a virtual facial expression based on a facial expression of the participant.

10. The method of claim 1, further comprising:
obtaining an indication of a request, from a participant, to display a 3D virtual participant depiction within the virtual interaction space; and
providing, for output and based on the indication, additional rendering information configured to cause the computing device to present, via the display device, the 3D virtual participant depiction within the virtual interaction space, wherein the 3D virtual participant depiction comprises a 3D representation of the participant, wherein providing the additional rendering information comprises providing the additional rendering information configured to cause the computing device to present a virtual action performed by the 3D virtual participant depiction based on an action performed by the participant.

11. A non-transitory computer-readable medium storing instructions operable to cause one or more processors to perform operations comprising:
obtaining, via an imaging device, interaction space image information indicative of an interaction space;
generating, based on the interaction space image information, virtual interaction space information corresponding to a virtual interaction space associated with a video conference, the virtual interaction space comprising a virtual three-dimensional (3D) structure representing the interaction space;
obtaining, via an artificial intelligence content generation (AICG) system, virtual object information for displaying a virtual object within the virtual interaction space, wherein the virtual object information comprises new content generated by the AICG system based on input data associated with user interactions and environmental contexts; and
providing, for output, and based on the virtual interaction space information and the virtual object information, rendering information configured to cause a computing device to present, via a display device, the virtual object within the virtual interaction space.

12. The non-transitory computer-readable medium of claim 11, wherein the virtual object comprises a virtual representation of a white board.

13. The non-transitory computer-readable medium of claim 11, wherein the virtual object comprises a virtual representation of a white board, and wherein the virtual representation of the white board is configured to be manipulated by a participant via an input device of the computing device.

14. The non-transitory computer-readable medium of claim 11, wherein the virtual object comprises a virtual representation of a physical object.

15. The non-transitory computer-readable medium of claim 11, wherein the virtual object information comprises content provided by a content service.

16. The non-transitory computer-readable medium of claim 11, the operations further comprising:
obtaining, from a plurality of users, a plurality of concurrent user inputs indicative of user interaction with a virtual object; and
prioritizing the plurality of concurrent user inputs based on at least one of predefined criteria or a user role.

17. The non-transitory computer-readable medium of claim 11, the operations further comprising:
obtaining a gesture indication indicative of detection, in user image information associated with the video conference, of a hand gesture made by a participant; and
providing, for output and based on the gesture indication, additional rendering information configured to cause the computing device to present, via the display device, a modification of a virtual position of the virtual object.

18. A system, comprising:
one or more memories; and
one or more processors configured to execute instructions stored in the one or more memories to:
obtain, via an imaging device, interaction space image information indicative of an interaction space;
generate, based on the interaction space image information, virtual interaction space information corresponding to a virtual interaction space associated with a video conference, the virtual interaction space comprising a virtual three-dimensional (3D) structure representing the interaction space;
obtain, via an artificial intelligence content generation (AICG) system, virtual object information for displaying a virtual object within the virtual interaction space, wherein the virtual object information comprises new content generated by the AICG system based on input data associated with user interactions and environmental contexts; and
provide, for output, rendering information configured to cause a computing device to present, via a display device and based on the virtual 3D structure, the virtual object within the virtual interaction space.

19. The system of claim 18, wherein the one or more processors are further configured to execute the instructions stored in the one or more memories to:
obtain an indication of a request, from a participant, to display a 3D virtual participant depiction within the virtual interaction space; and
provide, for output and based on the indication, additional rendering information configured to cause the computing device to present, via the display device, the 3D virtual participant depiction within the virtual interaction space, wherein the 3D virtual participant depiction comprises a 3D representation of the participant.

20. The system of claim 18, wherein the one or more processors are further configured to execute the instructions stored in the one or more memories to provide, for output, additional rendering information configured to cause the computing device to present an additional virtual object within the virtual interaction space, wherein the additional virtual object is configured to interact with the virtual object.
